(19) United States
(12) Patent Application Publication
(10) Pub. No.: US 2010/0150544 A1
(43) Pub. Date: Jun. 17, 2010

(54) Iris damper

(76) Inventor: Edward N. Koop, Olathe, KS (US)

Correspondence Address: Jeffrey Thurnau;The Gates Corporation, Mail Stop: IP Law Dept. 10-A3, 1551 Wewatta Street, Denver, CO, 80202, US

(21) Appl. No.: 12/316,775

(22) Filed: Dec. 16, 2008

(51) Int. Cl. G03B 9/08

(52) U.S. Cl. 396/453

(57) ABSTRACT

An iris damper comprising a housing, a plurality of iris blades moveable to open and close the damper, and the plurality of iris blades comprising a first cooperating pair of iris blades, each iris blade of the first cooperating pair having a linear edge which is cooperatively contactable along a predetermined length (L) with an opposing linear edge of the other iris blade in order to form a substantially gas tight seal between the first pair linear edges when the iris damper is closed.

### FIELD OF THE INVENTION

The invention relates to an iris damper, and more particularly to an iris damper having a first pair of blades, each blade of the pair having a linear edge which comes into contact along a predetermined length (L) with an opposing linear edge of the other blade in order to form a substantially gas tight seal between the linear edges when the iris damper is closed.

### BACKGROUND OF THE INVENTION

Damper systems that employ an iris shutter type construction for air flow restriction are generally referred to as iris dampers. Iris dampers are inserted into the duct work of forced-air ventilation systems. Iris dampers generally include an open circular cross-section which allows the flow of the force air through the damper.

Typical iris dampers utilize a plurality of blades made of thin gage metal. The blades are stacked on each other around the perimeter of the damper and utilize an actuating mechanism to synchronize the movement of the blades to cause the opening and closing of the iris. Thin gauge materials help maximize the range of motion. However, even with the use of thin gauge material there is limitation on how far the blades can come together in the center.

In operation, the iris blades pivot to obstruct the open circular cross-section, similar to the action of an iris shutter of a camera. However, even when in the fully closed position current large iris dampers for use in commercial ventilating applications still have an opening in the middle through which air continues to flow. These iris dampers have been used for controlling the rate of air flow, but do not stop the air flow entirely. The iris blades do not form a perfect circle when closed, due to the sectional nature of the iris blades. Many commercial air flow applications, such as heath care isolation suites and research laboratories, require the damper to modulate from one hundred percent open to one hundred percent closed.

To obtain a no flow condition some other type of closure device must be positioned upstream or downstream of the current iris damper. This adds to the complexity of the damper system installation.

Representative of the art is U.S. Pat. No. 6,796,328 to Myles which discloses a damper system with a sealing plug, which incorporates an air flow monitoring system. The damper system utilizes current designs of the iris damper and incorporates a sealing plug positioned in the open circular cross-section of the iris damper. One version of the sealing plug incorporates a sealing groove in the sealing plug, while another version employs different types of sealing gaskets. The sealing groove and sealing gaskets provide a positive seal about the sealing plug when the iris blades are in the closed position.

What is needed is an iris damper having a first pair of blades, each blade of the pair having a linear edge which comes into contact along a predetermined length (L) with an opposing linear edge of the other blade in order to form a substantially gas tight seal between the linear edges when the iris damper is closed. The present invention meets this need.

### SUMMARY OF THE INVENTION

The primary aspect of the invention is to provide an iris damper having a first pair of blades, each blade of the pair having a linear edge which comes into contact along a predetermined length (L) with an opposing linear edge of the other blade in order to form a substantially gas tight seal between the linear edges when the iris damper is closed.

Other aspects of the invention will be pointed out or made obvious by the following description of the invention and the accompanying drawings.

The invention comprises an iris damper comprising a housing, a plurality of iris blades moveable to open and close the damper, and the plurality of iris blades comprising a first cooperating pair of iris blades, each iris blade of the first cooperating pair having a linear edge which is cooperatively contactable along a predetermined length (L) with an opposing linear edge of the other iris blade in order to form a substantially gas tight seal between the first pair linear edges when the iris damper is closed.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the iris damper.

FIG. 2 is a front view of the iris damper.

FIG. 3 is a side view of the iris damper.

FIG. 4 is a front view of the iris damper blades in the fully closed position.

FIG. 5 is a front view detail of the iris damper blades.

FIG. 6 is a top view detail of the iris damper blades.

FIG. 7 is a front view of the iris damper blades in a partially closed position.

FIG. 8 is a front view of the iris damper blades in the fully open position.

### DETAILED DESCRIPTION OF THE PREFERRED EMBODIMENT

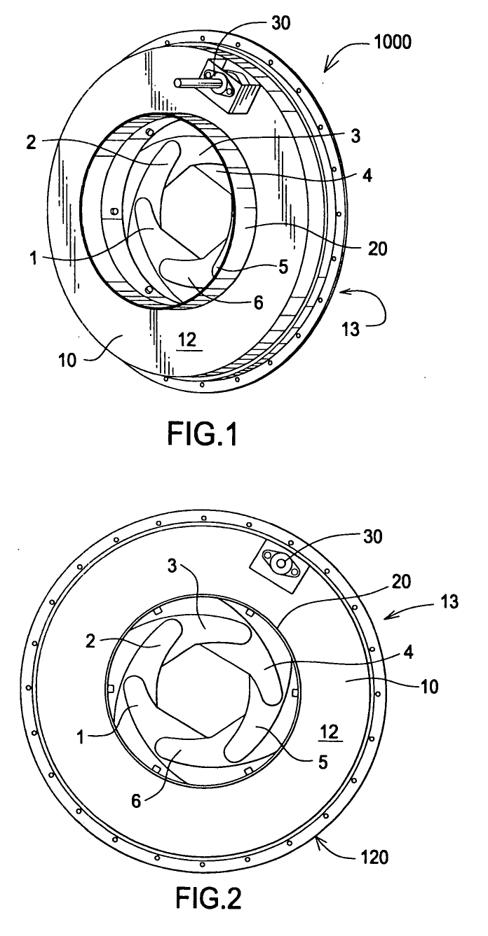

FIG. 1 is a perspective view of the iris damper. The current invention utilizes stacked pairs of blades. The blades have differing shapes. The differing shape of the blades allows the blades widths to be staggered, thereby allowing full closure of the damper using only the blades.

Full closure is accomplished primarily between one pair of diametrically opposed blades. The blades come into contact with each other when the damper is in the fully closed position. Neighboring pairs of diametrically opposed blades then come into proximity near the damper center, each pair separated by a different distance from any other pair. The differing distances allow for the gradual stacking of the blades as the damper closes. The staggered stacking of the blades has a benefit of allowing the use of heavier gauge materials. This allows the damper to be used in higher flow applications which place higher aerodynamic loads on the blades. Heavier gauge materials will also allow use at higher temperature applications and applications that may have particulate matter in the fluid flow. Complete closure of the damper allows it to perform functions that are advantageous in ducted systems. Fire and smoke control are suitable applications since the inventive damper can be fully closed.

Iris damper 1000 comprises a housing 10. Housing 10 has a flange 20 which allows the damper to be installed in a duct. Flange 20 extends through the damper and so a duct can be connected at each end of flange 20.

Damper 100 further comprises a plurality of damper blades 1, 2, 3, 4, 5, 6. The blades are equally spaced and arranged in a substantially circular manner within housing 10.

An actuator mechanism 30 mounted to housing 10 is used to move the blades. A driver such as an electric motor, pneumatic or hydraulic cylinder, or hand wheel or other suitable actuator known in the damper arts (not shown) can be attached to the actuator mechanism to allow automatic operation of the damper and blades. The blades move in unison during opening or closing of the damper. From fully open to fully closed, each blade swings through an arc of approximately 40°.

FIG. 2 is a front view of the iris damper. Flange 12 joins each half section 12, 13, of housing 10. Housing 10 can be split at flange 120 to perform maintenance on the blades and actuator mechanism. Fasteners 121 mount section 13 to flange 120.

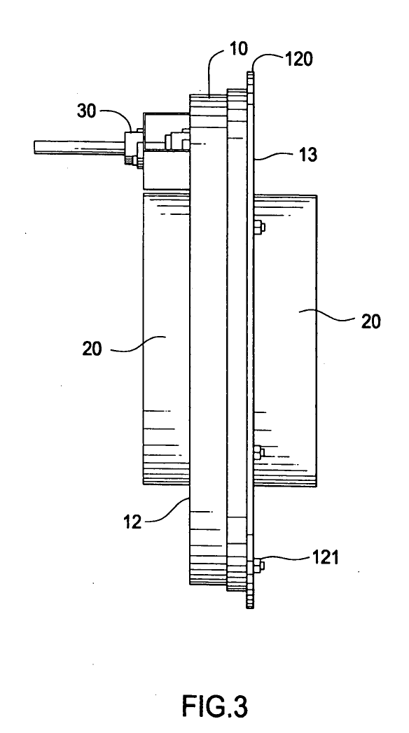

FIG. 3 is a side view of the iris damper. Flange 20 extends from both sides of housing 10 to allow connection of the damper to a duct (not shown).

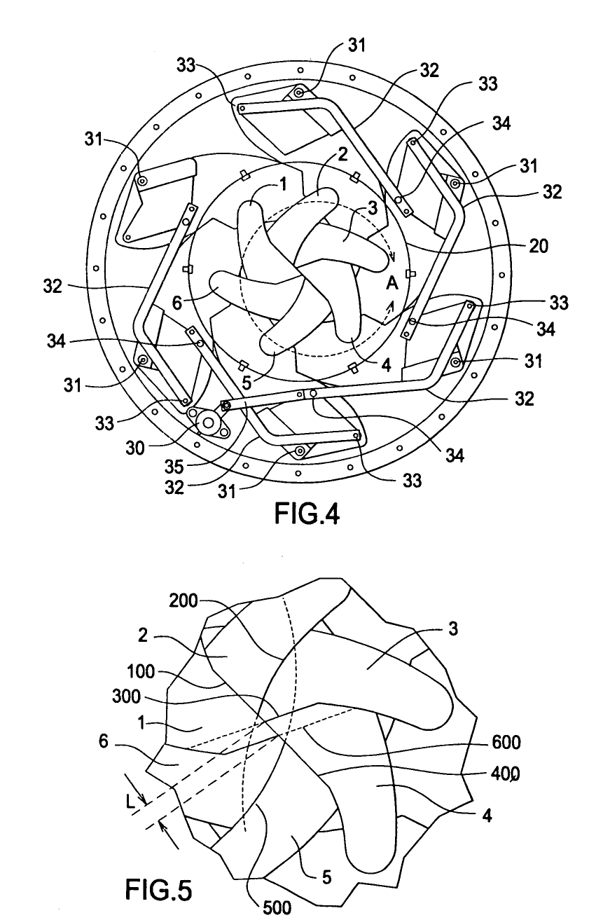

FIG. 4 is a front view of the iris damper blades in the fully closed position. For clarity section 13 is removed in this view. Each blade is connected to the housing 10 at a pivot 31. Adjacent blades, for example 5 and 6, are operably connected to each other by way of a member 32. Member 32 is moveably connected to each respective blade at a pivot 33, 34.

Actuator 30 is connected to the series of blades by a member 35. Member 35 is moveably connected between actuator 30 and pivot 34.

FIG. 5 is a front view detail of the iris damper blades. To fully close the damper, an inner edge of blade 1 and blade 4 come into contact, see edge 100 and 400 respectively. Edge 100 and edge 400 are linear edges which form a substantially gas tight seal along the edges when they are in contact along a predetermined length (L), namely, when the damper is fully closed. A gasket material may be applied along edge 100 and edge 400 to further enhance the sealing qualities of the blades.

Next blade 3 and blade 6 come into proximity, but edges 300 and 600 do not come into intimate contact due to the preexisting contact between blades 1 and 4 along length L. Put another way, blades 3 and 6 remain separated by a distance equal to or greater than the length (L) when the iris damper is fully closed. When the damper is fully closed each edge 300 and 600 is facing the other.

Next blade 2 and blade 5 come into proximity, but arcuate edges 200 and 500 do not come into contact due to the preexisting contact between blades 1 and 4 and the proximate relationship between blades 3 and 6 when the iris damper is closed. When the damper is closed each arcuate edge 200 and 500 is facing the other.

In effect, there are three pairs of blades in cooperative relation, namely, a first pair of blades 1 and 4, a second pair of blades 3 and 6, and a third pair of blades 2 and 5. Each pair of blades relates in a different manner compared to each of the other pairs, which allows the combined set of six blades to fully close without use of any other additional flow stopping component, for example, a center plug as is used in the prior art.

Although this description is given with respect to pairs of blades for the sake of clarity, during operation all six blades move simultaneously.

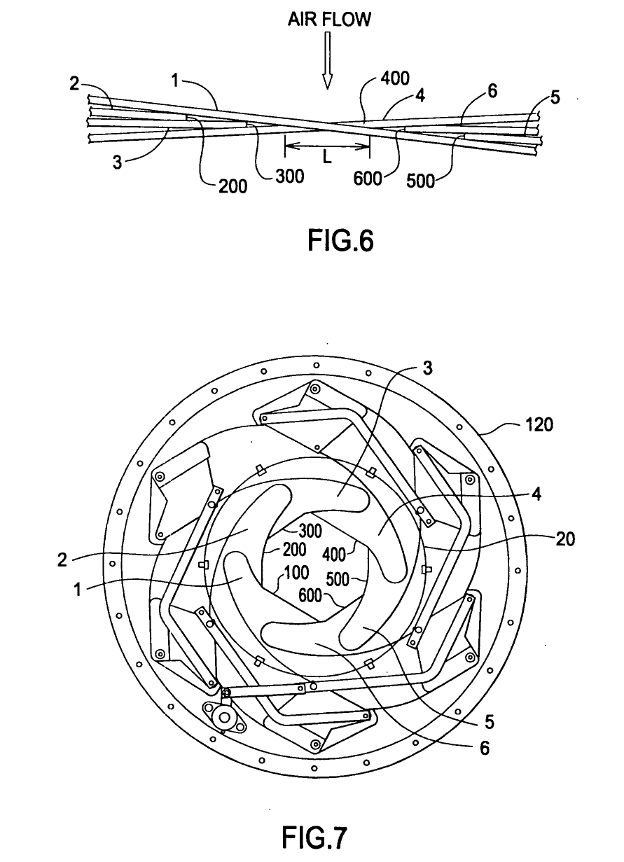

FIG. 6 is a top view detail of the iris damper blades. This top view illustrates the “stacked” configuration of the blades in the damper closed position. In the closed position, there is a gap between edges 300 and 600, and a gap between edges 200 and 500. The interleaved or stacked arrangement of the blades in the closed position provides reinforcement and strength against an air flow impinging the blades.

FIG. 7 is a front view of the iris damper blades in a partially closed position. The relationship between each pair of blades, and in particular, between each set of corresponding edges is shown. Section 13 is removed in this view.

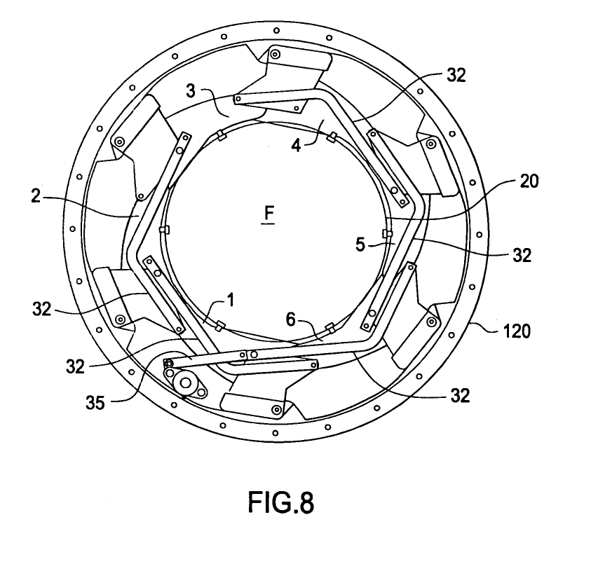

FIG. 8 is a front view of the iris damper blades in the fully open position. Each blade fully retracts into housing 10, thereby allowing unrestricted flow if air through the damper. Each member 32 nests in cooperative relation to each adjacent member 32 in the open position. No member 32 intrudes on the open flow area (F) which represents the full diameter of the duct flange 20.

Although a form of the invention has been described herein, it will be obvious to those skilled in the art that variations may be made in the construction and relation of parts without departing from the spirit and scope of the invention described herein.

I claim:

1. An iris damper comprising:
a housing;
a plurality of iris blades moveable to open and close the damper; and
the plurality of iris blades comprising a first cooperating pair of iris blades (1,4), each iris blade of the first cooperating pair having a linear edge (100,400) which is cooperatively contactable along a predetermined length (L) with an opposing linear edge of the other iris blade in order to form a substantially gas tight seal between the linear edges when the iris damper is closed.

2. The iris damper as in claim 1, wherein the iris damper comprises six iris blades.

3. The iris damper as in claim 1, where in the iris blades comprise a second cooperating pair of iris blades, each iris blade of the second cooperating pair moveable into proximity while remaining separated by a distance equal to or greater than the length (L) when the iris damper is closed.

4. The iris damper as in claim 3, wherein the iris blades comprise a third cooperating pair of iris blades, each iris blade of the third pair moveable into proximity while remaining separated by a predetermined distance when the iris damper is closed.

5. The iris damper as in claim 4, wherein each iris blade of the third cooperating pair of iris blades comprises an arcuate edge, each arcuate edge facing the other when the iris damper is closed.
